(19) United States
(12) Patent Application Publication
(10) Pub. No.: US 2009/0299781 A1
(43) Pub. Date: Dec. 3, 2009

(54) PROFILE MANAGEMENT AND CREATION METHOD AND APPARATUS IN A CATALOG PROCUREMENT SYSTEM

(75) Inventor: Macam S. Dattathreya, Sterling Heights, MI (US)

Correspondence Address: IBM CORPORATION (ACCSP);c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/130,178

(22) Filed: May 30, 2008

(51) Int. Cl. G06F 17/00; G06F 17/30; G06Q 40/00; G06Q 90/00

(52) U.S. Cl. 705/7; 705/27; 705/30; 705/40

(57) ABSTRACT

A catalog based purchasing and requisition system profile manager for a procurement services system that allows profile searching and editing features. The system provides simplified new profile creation, existing profile editing, profile grouping, customized profile copy and profile searching features.

### TECHNICAL FIELD

The present invention generally relates to systems and methods for the requisition of goods and services and more particularly to the requisition of goods and services from catalog vendors where purchases may be controlled and leveraged across companies and company groups.

### BACKGROUND

The present invention provides a system for creating and maintaining catalog profiles in a catalog based automated method for requisitioning goods and services. The system of the present invention provides additional features to those described in co-owned U.S. Pat. No. 7,155,403 (the '403 patent). The '403 patent is incorporated herein in its entirety.

A purchaser of goods or services may purchase an item from a catalog, for example, Catalog A. In an automated requisition system a profile may be created for each unique company (user) group (e.g. country, company Enterprise Procurement Services [ERP] system) used by the requisition system (e.g., SAP) using Catalog A. In operation, a given company group might have three companies with each company using a different ERP, for an automated system to function fully three catalog profiles must be created for a given catalog (assuming this single catalog is utilized by all three companies). A limitation in prior systems is that although a given catalog may be controlled by a catalog profile and associated with more than one company within more than one company group, business rules may require a user in a particular company group to buy from a particular catalog or catalogs, and such user will only see those catalogs associated with their company group. Thus, in such prior art requisition systems, catalogs are isolated to users by company group by associating company groups with each data item that exists in the various data files and code procedures. This isolation is preferred in order to affect purchasing control.

As a system is enabled to provide the necessary features to operate without a troubling level of skilled intervention, catalog profiles in such a system may become debilitatingly complex as the number of attributes and profiles for a given catalog require maintenance of, e.g., duplicate data across multiple profiles for each catalog.

Administrative staff must be employed to continually update the hosting requisition and catalog system such that both (1) new profiles are created for new catalogs and (2) current catalog profiles are edited where catalog offerings have changes.

Existing systems require continuing re-factoring of existing requisition and catalog systems (see, e.g., U.S. Pat. No. 5,319,542: System for ordering items using an electronic catalogue).

The present invention reduces the manual effort required to maintain and use automated catalog requisition systems. The present invention also increases efficiency without adversely effecting system control and functionality. For example, the present invention eases catalog profile maintenance without requiring programming or system level changes.

The present invention allows for:
a. Creating new profiles of a given catalog.
b. Maintaining multiple profiles of a single catalog when multiple profiles for a given catalog are needed to keep the requisition system's design intact.
c. Updating attributes of multiple profiles of the same catalog.
d. Deleting multiple profiles of the same catalog.

### SUMMARY

The present invention provides the following novel features:
a. Multiple profiles of a given supplier catalog may be made without creating each profile from scratch.
b. The ability to create from one to a plurality of profiles by utilizing a “Copy profile” function (copies an existing profile for editing in creating a similar additional profile).
c. Functions:
   i. “Add to source profile's group (link)” function to add newly created profiles to a source profile so a group (link) acts as a single profile for a given catalog. In this case a source profile acts as the group owner.
   ii. “Group (link) copied profiles” function to group the newly created profiles so that the new group (link) acts as a single profile for a given new catalog. In this case, a group member becomes the group owner.
   iii. “Save grouped (linked) profiles data” function to propagate the changes from a single profile to a grouped (linked) profile of a given catalog (i.e. group of catalog profiles of the same catalog, the catalog id and the company group code must be the same to form a group).
   iv. “Save selected profile's data” function to limit the changes to a single profile.
   v. “Remove from the group” function to remove a given profile from its group (unlink from the group).
   vi. “Add to group” function to add a given profile to the predefined group, based on the catalog id and the company group code, the profile is automatically added to the appropriate group (link to group).
   vii. “Search the group owner profiles” function and find profiles which are the group owners. ALL profiles are initially group owners if they do not belong to a group.
   viii. “Delete the grouped profiles” function to delete all the profiles of a given group.
   ix. “Delete the selected profile” function to delete a single profile in a group.

The present invention provides at least the following advantages over currently known systems:

(1) The requisition and catalog system's original operational logic is not changed.

(2) Adds additional features to the existing profile maintenance process without impacting the existing system.

(3) Provides the flexibility of updating profiles in accordance with pre invention installation methodology and post-invention methodology.

(4) Grouped profiles may be updated while updating a single profile.

(5) Reduced manual effort to maintain multiple profiles.

(6) Reduced cost and errors to maintain profiles.

(7) Grouping (linking) and Ungrouping (unlinking) profiles.

(8) Any number of profiles can be created in one click based on the given source catalog profile.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 illustrates the static connections between the components of the present invention illustrating catalog administrator (delegate) access to the Copy Profile and Grouping System (CPGS), the procurement application and the database directly;

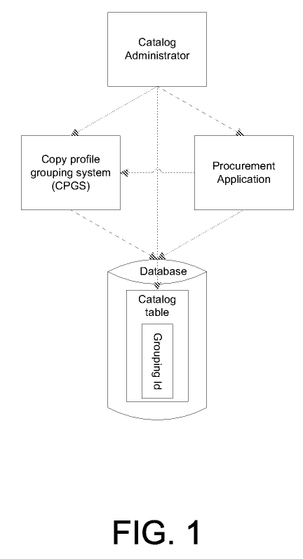

FIG. 2 is a flow diagram of a preferred embodiment of the present invention illustrating features of the present invention, including managing groups and group profiles;

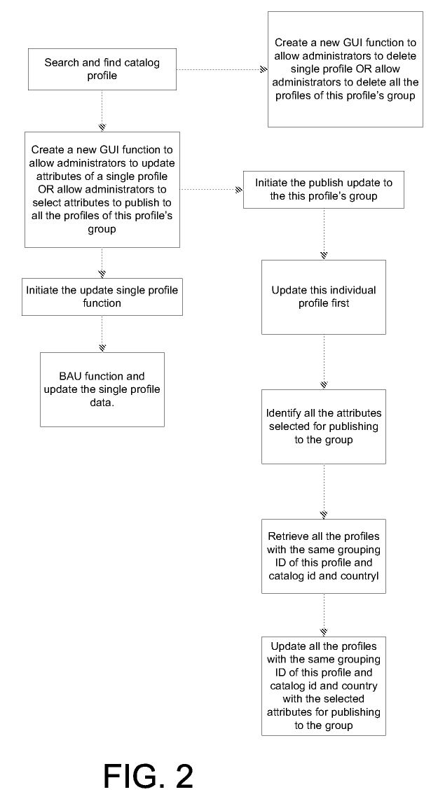

FIG. 3 is a process flow chart of a program designed to operate the system and apparatus of a preferred embodiment of the present invention;

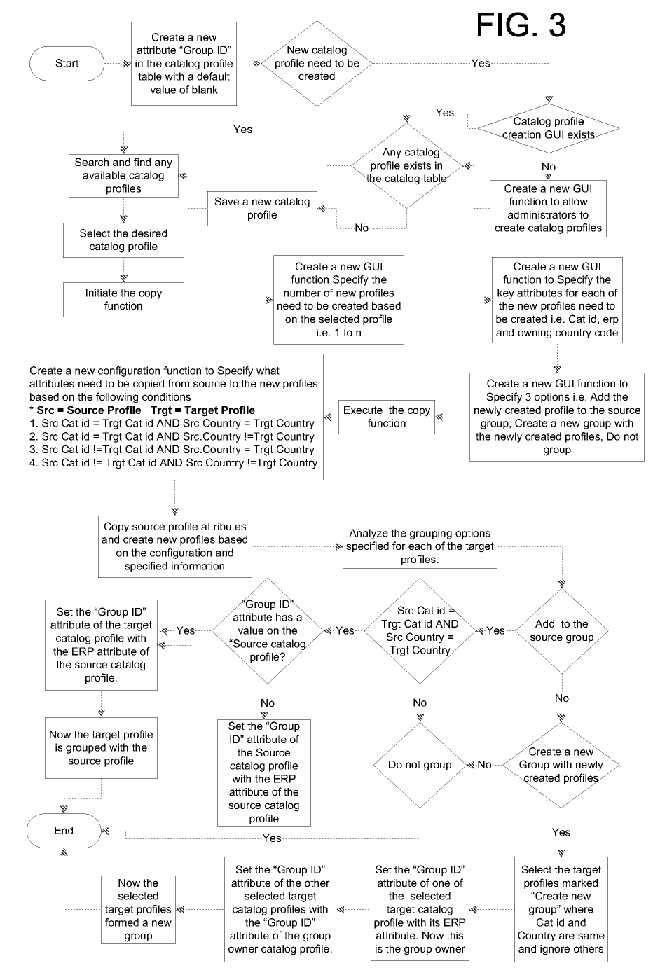

FIG. 4 is a flow diagram of a second embodiment of the present invention illustrating the creation of new groups and editing existing groups;

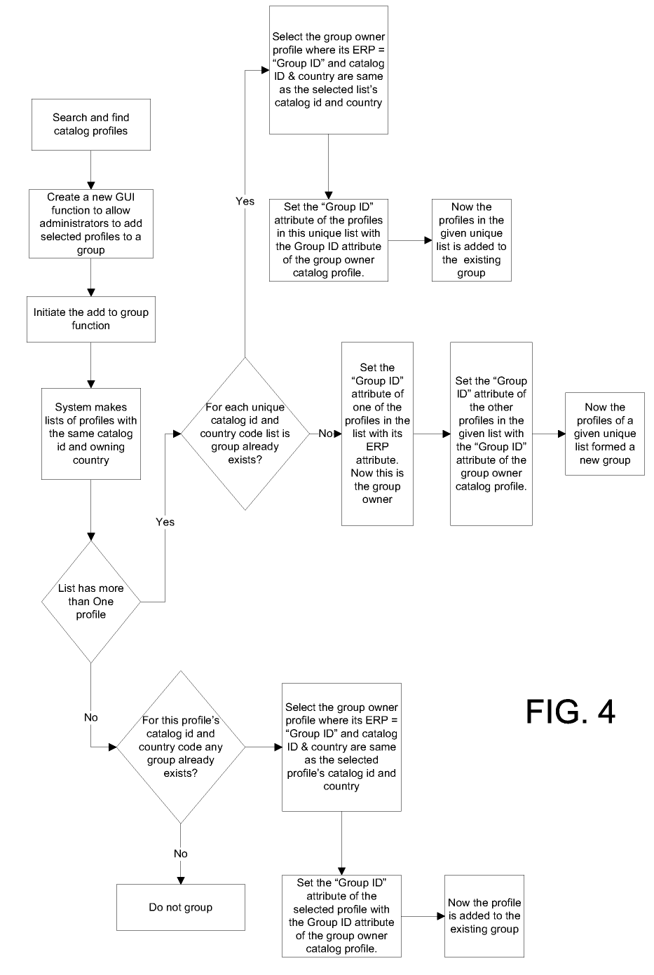

FIG. 5 is a flow diagram of the group edit/remove feature of the present invention; and

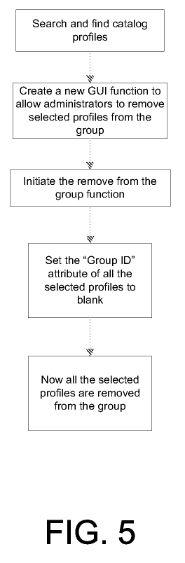

FIG. 6 is a flow diagram of the system of a preferred embodiment of the present invention.

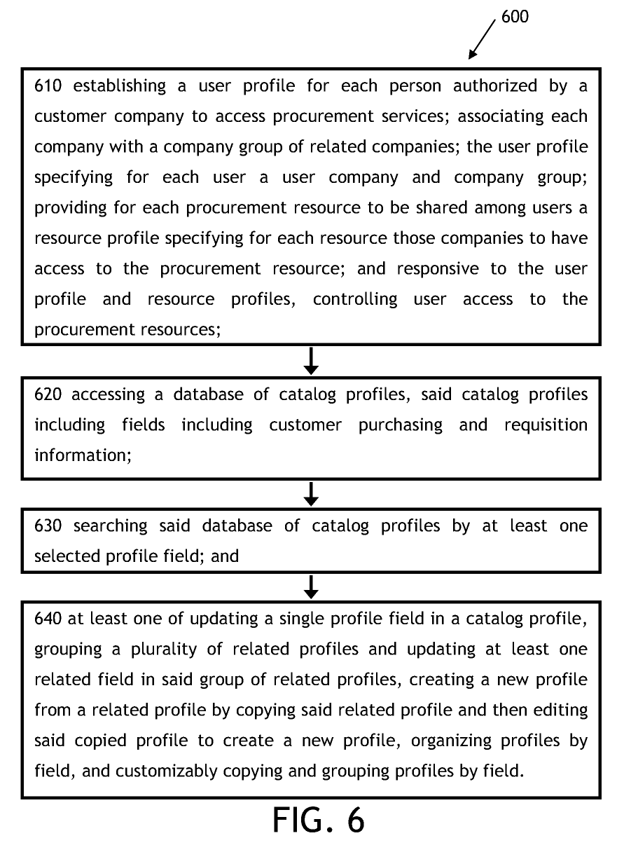

### DETAILED DESCRIPTION

Reference will now be made in detail to the subject matter disclosed, which is illustrated in the accompanying drawings. The present invention provides an efficient and a productive system to create and maintain catalog profiles in a procurement application.

The present invention provides flexibility in updating grouped profiles while updating a single profile. Additionally, the present invention provides means for specifying the attributes that need to be propagated to grouped profiles when updating a single profile while grouping (linking) and ungrouping (unlinking) profiles. In a currently preferred embodiment, the present invention may be utilized to create profiles in a single step while maintaining duplicate profile information across multiple profiles of a same catalog.

The invention includes the following components in its currently preferred embodiment:
a. Copy profile and grouping system (CPGS): guides the catalog administrator, or a delegate, through the steps (some of them conditional) necessary to transform a procurement application and to copy and group catalog profiles (reduced maintenance/administration time). The system also can update grouped profiles while updating a single profile. The system allows the attributes of a single profile to be propagated to a group, e.g., in a single GUI, an administrator can copy a source profile and create “N” number of profiles. The grouping options can be selected in that GUI also. Based on the configured rules, the grouping will be performed.
b. Procurement Application: conducts the purchasing of products and services using a workflow, often involving multiple parties. Aside from purchasing, procurement applications provide oversight, approvals, and accounting functionality. Example applications include IBM Buy on demand, Ariba, and SAP's EBP/SRM.
c. Database: a comprehensive collection of related data organized for convenient access. Example databases include DB2, Sybase, Oracle, and MySgL.

With the CPGS of the present invention, profile creation and maintenance time is reduced. This decreases cost and manual errors in maintaining the system.

The execution flow of the present invention is illustrated in the Figures. The following functions are provided and utilized in the present invention:

“Copy profile” function to copy an existing profile and create multiple profiles.

“Add to source profile's group (link)” function to add newly created profiles (certain restrictions apply) to the source profile so that the group (link) acts as a single profile for a given catalog. In this case the source profile is the group owner.

“Group (link) copied profiles” function to group the newly created profiles so that the new group (link) acts as a single profile for a given new catalog. In this case, one of the group members will be made the group owner.

“Save grouped (linked) profiles data” function to propagate the changes from single profile to the grouped (linked) profiles of a given catalog (i.e. group of catalog profiles of the same catalog, the catalog id and the company group code are preferably the same to form a group).

“Save selected profile's data” function to limit the changes to the single profile.

“Remove from the group” function to remove a given profile from its group (unlink from the group).

“Add to group” function to add a given profile to the predefined group, based on the catalog id and the company group code, the profile will be automatically added to the appropriate group (link to the group if exists).

“Search the group owner profiles” function and find profiles belonging to a group or a group owner (all profiles are initially group owners unless they belong to a group).

“Delete the grouped profiles” function to delete all the profiles of a given group. “Delete the selected profile” function to delete a single profile in a group.

Turning now to the Figures, the flow execution of the CPGS guides the catalog administrator or delegate through a series of steps to enhance the functionality of a procurement application to reduce the manual effort and errors while maintaining catalog profiles.

Multiple profiles of a given catalog may be linked (grouped) with a “Group ID” to identify the group. To group catalogs, the catalog id and the catalog owner country must be the same. Individual catalog profiles may be added or removed from the group. All profiles of a given group can be updated when an individual profile is updated. While updating a single profile of a given group, profile attributes can be selected to publish to a group. Each profile has a “Group ID” attribute to identify its grouping id. The group owner's ERP ID and the Group ID are preferably the same.

When working with the profiles, either group owners or individual profiles can be searched. Profiles may also be copied.

A catalog profile may be created from scratch using the profile GUI function or it may be created by using a new GUI function to copy an existing profile. The profile attributes can be configured to allow the copy function to use only certain selectable fields when creating new profiles. There are four conditions in which the configuration can exist to describe what attributes can be copied, e.g., (1) (Source profile's catalog ID=Target Profile's catalog ID) AND (Source profile's country=Target profiles country); (2) (Source profile's catalog ID=Target Profile's catalog ID) AND (Source profile's country !=Target profiles country); (3) (Source profile's catalog ID !=Target Profile's catalog ID) AND (Source profile's country=Target profiles country); and (4) (Source profile's catalog ID !=Target Profile's catalog ID) AND (Source profile's country !=Target profiles country). Additionally, In one GUI function an administrator can copy one source profile and create “N” number of profiles.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. An improved catalog based purchasing and requisition system profile manager for a procurement services system, including:
a method for providing procurement services to a plurality of customer companies with complex accounting rules while providing secure information viewing in support of said customer companies, said customer companies being organized in a plurality of customer company groups and procurement coalitions for volume discounts and access to shared contracts with respect to a plurality of vendors, with procurement contracts leveraged across company groups, comprising the steps of:
providing a front end requisition and catalog server for providing a user interface to a user at a customer company browser to access catalogs and commodities managed by said enterprise and for providing approval notices and receiving approve/reject data with respect to customer approvers; inputs to said front end requisition and catalog server from an enterprise procurement services system including requisition status, purchase order status and contracts, cost centers, currency exchange rates, general ledger accounts, purchase order history invoices, purchase order history receipts, and confirmations; outputs from said requisition and catalog server to said procurement services system including requisitions and positive confirmation responses; inputs to said front end requisition and catalog server from said customer company browser including submit requisition; outputs from said requisition and catalog server to said customer company browser including approval/rejection notices, status display, and negative and positive confirmations; with notice and response data being exchanged between said requisition and catalog server and browser; inputs to said front end requisition and catalog server from a vendor system including vendor catalogs via an enterprise electronic data interchange application; inputs to said front end requisition and catalog server from an enterprise requisition and catalog system including postal code validation data; inputs to said front end requisition and catalog server including human resource extract data from an enterprise hub server; providing said enterprise procurement services system managed by said enterprise for accepting requisitions from said front end requisition and catalog server entered by said user and responsive thereto for causing said electronic data interchange application to generate transactions to said vendors and for generating accounting transactions to a leveraged procurement network data warehouse facility for said requisitions; inputs to said enterprise procurement services system from said front end requisition and catalog server including requisitions and positive confirmation responses; and outputs to said front end requisition and catalog server from said enterprise procurement services system including requisition status data, purchase order status and contracts data, cost center data, currency exchange rates, general ledger accounts, purchase order history invoices purchase order history receipts, and order confirmations; inputs to said enterprise procurement services system from said enterprise hub server including cost center data; and outputs to said hub server from said enterprise procurement services system including a company process control table, vendor master updates, and accounting detail; inputs to said enterprise procurement services system from said electronic data interchange application including purchase order acknowledgments, invoices, payment status and file transfer check reconstructions; and outputs from said enterprise procurement services system to said electronic data interchange application including purchase orders, invoice rejections and payments; inputs to said enterprise procurement services system from operator terminals including process purchase orders, requests for quotes, and contracts data, create/change vendor master data, invoice processing; payment proposal data, and payment post and print; inputs to said enterprise procurement services system including currency exchange rate data from an external financial services server; and output from said enterprise procurement services system to vendors including paper and fax purchase order documents; inputs to said enterprise electronic data interchange application from said vendor including purchase acknowledgments and invoices, and outputs from said electronic data interchange application to said vendor including purchase orders and invoice rejections; inputs to said enterprise electronic data interchange application including payments from a payment source and outputs from said enterprise electronic data interchange application including payments to customer electronic data interchange applications; providing said leveraged procurement network hosted data warehouse facility for storing and monitoring said electronic data interchange transactions and accounting transactions; providing said enterprise hub server for transferring data between said front end requisition and catalog server, said back-end purchasing system, and said data warehouse facility; inputs to said enterprise procurement services hub server from said enterprise procurement services system including company process control table, vendor master updates and accounting detail; outputs from said enterprise procurement services hub server including human resource extract data, extracted from customer employee data, to customer requisition and catalog system; outputs from said enterprise procurement services hub server to a customer back-end purchasing system including vendor master data, invoice detail, payment detail and bank clearing detail data; inputs to said enterprise procurement services hub server further including cost centers data; said customer back-end purchasing system also receiving goods receipts from customer receiving; establishing in a computer database a user profile for associating acceptable accounting and system controls to each person authorized by a customer company to access said procurement services; associating each said company with a company group of related companies; providing common code defining workflow components common to all companies within said company group, including accounting validation and approval processing; specifying in said user profile for each said user a user company and company group so as to define said controls based on company and company group by collecting in said user profile each of a plurality, of users into a user profile table associating acceptable accounting and system controls for each person authorized by a customer company to access procurement services for leveraging access and maintaining isolation of data by identifying a user at log on as associated with a particular company group; providing in a hub server a company group human resources file connected through a fire wall to a requisition and catalog server for creating and maintaining said user profile table; said procurement services including process requirements and data resources accessible only to those users identified in their profiles as members of a particular company and, therefore, company group and including catalogs, contracts, cost centers defining departments that can be charged, a chart of accounts defining general ledger account codes, entries in said user profile table, business rules and defaults including those affiliated with accounting and specifying fields that must be completed in creating a requisition and default data to be entered in those fields; providing in each entry for a user in said user profile a company group code a company code, a plant code specifying ship to location, an employee serial number, and an E-mail address; using said company group code and said company code responsive to user login to associate said user with a given company in a company group for responsive to user selection of a shop-from-a-catalog button on a user browser, controlling catalog application code to display to said user only those catalogs for which a corresponding catalog profile includes said user's company in a resource profile; specifying departments that can be charged across companies in a company group; selectively allowing a user to initiate requests for other users, view general ledger account codes associated with commodity codes by company group, company group specific business rules including accounting business rule defaults specifying fields required to be filled in by said user based on item being bought; said resource profile providing for each procurement resource to be shared among said users a computer database specifying for each resource those said companies to have access to and share said procurement resource;
and responsive to said user profile and said resource profiles controlling user access to said procurement resources, wherein the improvement comprises:
accessing a database of catalog profiles, said catalog profiles including fields including customer purchasing and requisition information;
searching said database of catalog profiles by at Least one selected profile field; and
at least one of updating a single profile field in a catalog profile, grouping a plurality of related profiles and updating at least one related field in said group of related profiles, creating a new profile from a related profile by copying said related profile and then editing said copied profile to create a new profile, organizing profiles by field, and customizably copying and grouping profiles by field.
